(19) United States
(12) Patent Application Publication
(10) Pub. No.: US 2010/0066329 A1
(43) Pub. Date: Mar. 18, 2010

(54) SUPPLY WITH FREQUENCY CONVERSION FUNCTION AND COMPUTER SYSTEM THEREOF

(75) Inventors: CHI-MO CHIU, Taipei (TW); YU-CHENG SHEN, Taipei (TW); CHUAN-CHANG CHOU, Taipei (TW); KUO-CHEN HUANG, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei (TW)

(21) Appl. No.: 12/558,664

(22) Filed: Sep. 14, 2009

(30) Foreign Application Priority Data
Sep. 18, 2008 (TW) 097135801

(51) Int. Cl. G05F 1/10

(52) U.S. Cl. 323/282

(57) ABSTRACT

The invention discloses a power supply with a frequency conversion function. The power supply is connected with a motherboard. The power supply includes a pulse width modulation (PWM) controller, a direct current-direct current (DC-DC) converter, and a switch resistor modulation circuit. The PWM controller generates a PWM signal. The DC-DC converter is connected with the PWM controller and the motherboard, and it generates a plurality of voltages to the motherboard after it receives the PWM signal. The switch resistor modulation circuit provides a first resistance value and a second resistance value switched to correspondingly generate a first switching frequency or a second switching frequency. The second resistance value is larger than the first resistance value. The second switching frequency is smaller than the first switching frequency.

### FIELD OF THE INVENTION

The invention relates to a power supply with a frequency conversion function and a computer system thereof and, more particularly, to a computer system with which a user can make a power supply operate at different switch frequencies according to higher power consumption demand and a lower power consumption demand.

### BACKGROUND OF THE INVENTION

Generally speaking, a computer system has a power supply therein. The power supply can provide a stable direct current (DC) voltage such as 12V or 5V to a motherboard of the computer system to allow the computer system to operate.

FIG. 1 is a schematic diagram showing a conventional power supply used at a computer system. The power supply mainly includes an electromagnetic interference (EMI) and bridge rectifier 11, an active power factor correction circuit (active PFC circuit) 13, a direct current-direct current (DC-DC) converter 15, and a pulse width modulation (PWM) controller 17.

First, an alternating current (AC) voltage source is connected with the EMI and bridge rectifier 11. The AC voltage source is an AC voltage such as 110V or 220V outputted by a general outlet. The EMI and bridge rectifier 11 is mainly used for suppressing an electromagnetic wave generated by the AC voltage source, and it rectifies the AC voltage with positive and negative phases to the AC voltage with a single phase via a bridge rectifier. Then, the AC voltage with a single phase is transmitted to the active PFC circuit 13. The active PFC circuit 13 is mainly used for adjusting input time and waveform of input AC to make the waveform of the input AC and the waveform of the DC voltage outputted by the active PFC circuit 13 as consistent as possible, and then a power factor (PF) approaches one. Furthermore, the active PFC circuit 13 increases the DC voltage outputted by itself to a voltage between 380 V and 400 V. Then, the DC voltage (380 V to 400 V) is transmitted to the DC-DC converter 15. The DC-DC converter 15 is mainly used for converting inputted big voltage and small current (380 V to 400 V) to small voltage and big current (such as +5V, +3.3V, +12V, −12V) and providing the small voltage and big current (such as +5V, +3.3V, +12V, −12V) to the motherboard 30 of the computer system.

Additionally, the DC-DC converter 15 is connected with the PWM controller 17. The PWM controller 17 is mainly used for controlling the power (watt, W) outputted by the DC-DC converter 15 to the motherboard 30. The PWM controller 17 may output a PWM signal to the DC-DC converter 15 and utilize a switching frequency of the PWM signal to switch a switch in the DC-DC converter 15 to make the DC-DC converter 15 output specific power to the motherboard 30. That is, the lower the switching frequency of the PWM signals is, the lower a switching speed of the switch in the DC-DC converter 15 is. As a result, the power outputted by the DC-DC converter 15 to the motherboard 30 is lower. On the contrary, the higher the switching frequency of the PWM signal is, the higher the switching speed of the switch in the DC-DC converter 15 is, and then the power outputted by the DC-DC converter 15 to the motherboard 30 is higher.

The switching frequency of the PWM signal is determined by a reference voltage pin (called Vref pin for short hereinafter), a switch resistor/capacitor pin (called RT/CT pin for short hereinafter) of the PWM controller 17, and a switch resistor (RT) externally connected between the Vref pin and the RT/CT pin. The RT/CT pin is charged or discharged via the switch resistor (RT) by a reference voltage (Vref) outputted by the Vref pin, and the time for charging and discharging the RT/CT pin is changed by controlling the value of the switch resistor (RT) to generate switching frequencies with different values. Generally speaking, the value of the switching frequency relates to the value of the switch resistor (RT). The larger the resistance value of the switch resistor (RT) is, the lower the switching frequency is. On the contrary, the lower the resistance value of the switch resistor (RT) is, the higher the switching frequency is.

The power supply has a plurality of field effect transistor switches (called metal-oxide semiconductor (MOS) switch for short hereinafter). Since the MOS switches continually conducts or not according to the switching frequency, a switch loss results. The value of the switch loss generated by the MOS switches is directly proportional to the value of switching frequency. That is, a higher switching frequency can generate higher power to the motherboard 30, but a high switch loss results at the same time. On the contrary, although a lower switching frequency can reduce the switch loss, it may cause the power outputted to the motherboard 30 to be insufficient.

Considering the power outputted to the motherboard 30 and the switch loss, a conventional power supply utilizes the optimization between the power and the switch loss. That is, the conventional power supply uses a constant switching frequency which can make the power and the switch loss balanced. The switching frequency of the conventional power supply is usually 100 KHz, and thus the DC-DC converter 15 can output power with a constant value to the motherboard 30. The power is generally 300 W. When the computer system operates at the constant switching frequency (100 KHz) and outputs the constant power (300 W) to the motherboard 30, both of the efficiency of the computer system operated by a user in a general operating environment and an acceptable switch loss can be maintained.

However, as peripherals become more and more, the power needed by the motherboard 30 becomes higher and higher. The constant power (300 W) generated via the constant switching frequency (100 KHz) sometime causes the efficiency of the computer system to be reduced. Additionally, even if the computer system operates at an environment requiring less power, since the conventional power supply uses the constant switching frequency (100 KHz), the switch loss consumed by the conventional power supply cannot be reduced. Since people have strong awareness to save power nowadays, it is a waste.

### BRIEF SUMMARY OF THE INVENTION

The invention relates to a power supply with a frequency conversion function connected with a motherboard. The power supply with the frequency conversion function includes a PWM controller, a DC-DC converter, and a switch resistor modulation circuit. The PWM controller generates a PWM signal and has two pins. The DC-DC converter is connected with the PWM controller and the motherboard, and it generates a plurality of voltages to the motherboard after it receives the PWM signal. The switch resistor modulation circuit provides a first resistance value and a second resistance value switched between the two pins to correspondingly generate the PWM signal having a first switching frequency or a second switching frequency. The second resistance value is larger than the first resistance value. The second switching frequency is smaller than the first switching frequency.

Furthermore, the invention relates to a power supply with a frequency conversion function connected with a motherboard of a computer system. The power supply with the frequency conversion function includes a PWM controller, a DC-DC converter, and a switch resistor modulation circuit. The PWM controller generates a PWM signal and has two pins. The DC-DC converter is connected with the PWM controller and the motherboard, and it generates a plurality of voltages to the motherboard after it receives the PWM signal. The switch resistor modulation circuit provides a first resistance value, a second resistance value, and a third resistance value switched between the two pins of the PWM controller to correspondingly generate the PWM signal having a first switching frequency, a second switching frequency, or a third switching frequency. The second resistance value is larger than the first resistance value. The first resistance value is larger than the third resistance value. The third switching frequency is larger than the first switching frequency. The first switching frequency is larger than the second switching frequency.

Additionally, the invention relates to a computer system. The computer system includes a motherboard and a power supply. The power supply is connected with the motherboard, and it can provide a plurality of voltages. The power supply includes a PWM controller, a DC-DC converter, and a switch resistor modulation circuit. The PWM controller generates a PWM signal and has two pins. The DC-DC converter is connected with the PWM controller and the motherboard, and it generates the voltages to the motherboard after it receives the PWM signal The switch resistor modulation circuit provides a first resistance value and a second resistance value switched between the two pins to correspondingly generate the PWM signal having a first switching frequency or a second switching frequency. The second resistance value is larger than the first resistance value. The second switching frequency is smaller than the first switching frequency.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional power supply used at a computer system;

FIG. 2 is a schematic diagram showing a power supply with a frequency conversion function according to an embodiment of the invention; and

FIG. 3 is a schematic diagram showing a switch resistor modulation circuit in the power supply according to an embodiment of the invention.

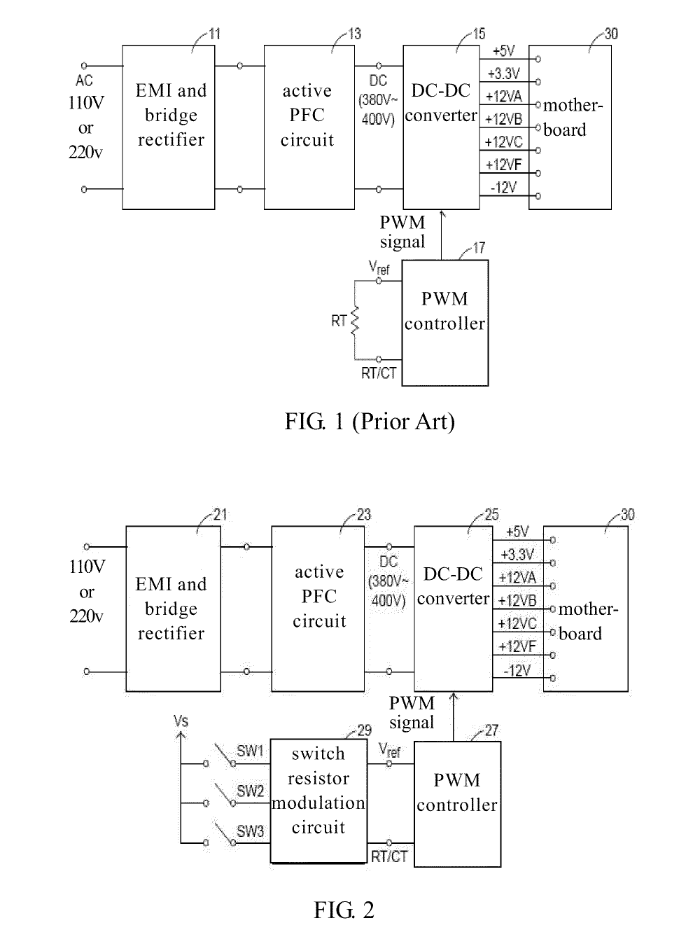

### DETAILED DESCRIPTION OF THE EMBODIMENTS

A switch resistor modulation circuit is mainly used at a power supply with a frequency conversion function according to the invention to allow a user to change a switch resistance value between a Vref pin and a RT/CT pin of a PWM controller according to different demands such as increasing efficiency or reducing power consumption for the computer system to make the PWM controller generate switch frequencies with different values. Then, the power outputted to the motherboard by the computer system is changed to improve the efficiency of the computer system or reduce the power consumption.

FIG. 2 is a schematic diagram showing a power supply with a frequency conversion function according to an embodiment of the invention. A power supply mainly includes an EMI and bridge rectifier 21, an active PFC circuit 23, a DC-DC converter 25, a PWM controller 27, and a switch resistor modulation circuit 29. The switch resistor modulation circuit 29 is connected between a Vref pin and a RT/CT pin of the PWM controller 27. The switch resistor modulation circuit 29 further has a first switch (SW1), a second switch (SW2), and a third switch (SW3). The motherboard 30 is connected with the DC-DC converter 25 to receive a plurality of voltages outputted by the power supply.

When the user thinks that a motherboard 30 in the computer system to be used does not need large power provided by the power supply, he or she may press the first switch (SW1). Since the first switch (SW1) conducts, the switch resistor modulation circuit 29 connected between the Vref pin and the RT/CT pin of the PWM controller 27 generates a switch resistor having a first resistance value. Consequently, the PWM controller 27 can generate a correspondingly switching frequency according to the switch resistor having the first resistance value. The switching frequency may be 100 KHz, and the PWM controller 27 outputs the PWM signal to the DC-DC converter 25 via the switching frequency (100 KHz). Afterwards, the DC-DC converter 25 generates correspondingly power such as 300 W according to the received PWM signal and outputs the correspondingly power to the motherboard 30 to make the computer system operate at a normal mode.

When the user thinks that the computer system to be used may reduce the power provided to the motherboard 30 by the power supply to save power, he or she may press the second switch (SW2). Since the second switch (SW2) conducts, the switch resistor modulation circuit 29 connected between the Vref pin and the RT/CT pin of the PWM controller 27 generates the switch resistor having a second resistance value. The second resistance value is larger than the first resistance value. As a result, the PWM controller 27 generates the correspondingly switching frequency according to the switch resistor having the second resistance value. The correspondingly switching frequency may be 80 KHz, and the PWM controller 27 outputs the PWM signal to the DC-DC converter 25 via the switching frequency (80 KHz). The DC-DC converter 25 generates the correspondingly power such as 250 W according to the received PWM signal and outputs the correspondingly power to the motherboard 30 to make the computer system operate at a power save mode.

When the user thinks that the computer system to be used will operate at an over clocking mode, and the power supply needs to provide a higher power to the motherboard 30, he or she may press the third switch (SW3). Since the third switch (SW3) conducts, the switch resistor modulation circuit 29 connected between the Vref pin and the RT/CT pin of the PWM controller 27 generates the switch resistor having a third resistance value. The third resistance value is smaller than the first resistance value. As a result, the PWM controller 27 generates the correspondingly switching frequency according to the switch resistor having the third resistance value and outputs the PWM signal to the DC-DC converter 25. The correspondingly switching frequency may be 120 KHz, and the PWM controller 27 transmits the PWM signal to the DC-DC converter 25 via the switching frequency (120 KHz). The DC-DC converter 25 generates the correspondingly power such as 350 W according to the received PWM signal and outputs the correspondingly power to the motherboard 30 to make the computer system operate at the OC mode.

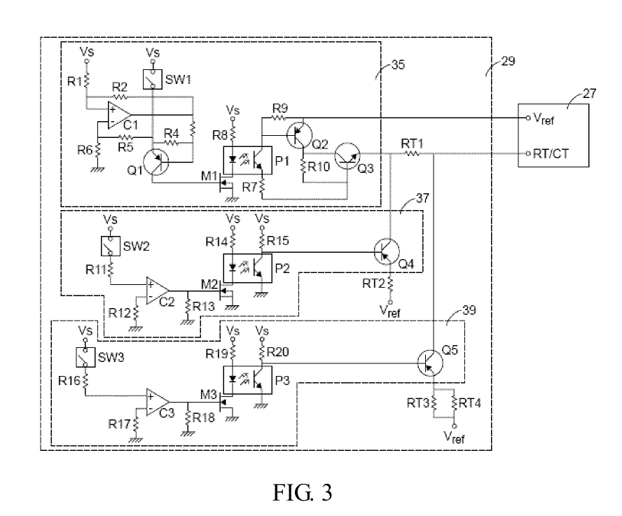

FIG. 3 is a schematic diagram showing a switch resistor modulation circuit in the power supply according to an embodiment of the invention. The switch resistor modulation circuit 29 is connected with the Vref pin and the RT/CT pin of the PWM controller 27. Additionally, the switch resistor modulation circuit 29 includes a first control circuit 35, a second control circuit 37, and a third control circuit 39.

Only one of the first switch (SW1), the second switch (SW2), and the third switch (SW3) may be triggered at the same time according to an embodiment of the invention. When the first switch (SW1) is triggered, the first control circuit 35 only provides the first switch resistor (RT1) to be connected with the Vref pin and the RT/CT pin. When the second switch (SW2) is triggered, the second control circuit 37 provides the first switch resistor (RT1) and the second switch resistor (RT2) connected in series to be connected with the Vref pin and the RT/CT pin. When the third switch (SW3) is triggered, the third control circuit 39 provides the third switch resistor (RT3) and the fourth switch resistor (RT4) connected in parallel to be connected with the Vref pin and the RT/CT pin. The equivalent resistance value of the third switch resistor (RT3) and the fourth switch resistor (RT4) connected in parallel is smaller than that of the first switch resistor (RT1).

Various switch resistor modulation circuits 29 with a same function may be designed by people skilled in the art according to the illustration of the embodiment in the invention. The circuit shown in FIG. 3 is just taken as a workable example, but not used for limiting the invention.

In the first control circuit 35, when the first switch (SW1) is not triggered, an input voltage of a positive input of a first comparator (C1) is larger that of the negative input of the first comparator (C1) to make an output of the first comparator (C1) output a high level. As a result, a first bipolar junction transistor (Q1), a first MOS transistor (M1), and a first optical coupler (P1) is turned off, and thus a second bipolar junction transistor (Q2) and a third bipolar junction transistor (Q3) do not act.

When the first switch (SW1) is triggered, the input voltage of the positive input of the first comparator (C1) is smaller than that of the negative input to make the output of the first comparator (C1) output a low level. Consequently, the first bipolar junction transistor (Q1), the first MOS transistor (M1), and the first optical coupler (P1) is turned on to make the second bipolar junction transistor (Q2) and the third bipolar junction transistor (Q3) turned on. As a result, the first switch resistor (RT1) is connect with the Vref pin and the RT/CT pin.

In the second control circuit 37, when the second switch (SW2) is not triggered, the input voltage of the positive input of the second comparator (C2) is smaller than that of the negative input to make the output of the second comparator (C2) output a low level. Consequently, the second MOS transistor (M2) and the second optical coupler (P2) do not act, and thus the fourth bipolar junction transistor (Q4) does not act.

When the second switch (SW2) is triggered, the input voltage of the positive input of the second comparator (C2) is larger than that of the negative input to make the output of the second comparator (C2) output the high level. Consequently, the second MOS transistor (M2) and the second optical coupler (P2) are turned on to make a fourth bipolar junction transistor (Q4) act. As a result, the first switch resistor (RT1) and the second switch resistor (RT2) connected in series are connected with the Vref pin and the RT/CT pin.

In the third control circuit 39, when the third switch (SW3) is not triggered, the input voltage of the positive input of the third comparator (C3) is smaller than that of the negative input to make the output of the third comparator (C3) output the low level. As a result, the third MOS transistor (M3) and a third optical coupler (P3) do not act, and thus a fifth bipolar junction transistor (Q5) do not act.

When the third switch (SW3) is triggered, the input voltage of the positive input of the third comparator (C3) is larger than that of the negative input to make the output of the third comparator (C3) output the high level. Consequently, the third MOS transistor (M3) and the third optical coupler (P3) are turned on to make the fifth bipolar junction transistor (Q5) act. As a result, the third switch resistor (RT3) and the fourth switch resistor (RT4) connected in parallel are connected with the Vref pin and the RT/CT pin.

As a result, with the power supply with the frequency conversion function used at the computer system according to the invention, the user can initiatively switch the first switch (SW1), the second switch (SW2), and the third switch (SW3) of the switch resistor modulation circuit according to different demands such as requiring better efficiency of the computer system or reducing the power consumption. Then, the switch resistor modulation circuit can generate different resistance values to make the PWM controller connected with the switch resistor modulation circuit generate the correspondingly switching frequency, and the PWM signal is outputted to the DC-DC converter via the correspondingly switching frequency. As a result, the DC-DC converter can correspondingly output different power to the motherboard 30 according to the switch resistors with different the resistance values to make the computer system operate in the normal mode, the power save mode, or the over clocking mode.

Furthermore, the power supply with the frequency conversion function according to the invention is controlled to be in the normal mode, the power save mode, or the over clocking mode via three switches. People skilled in the art may use two switches to control the power supply with the frequency conversion function to operate in the normal mode and the power save mode or the normal mode and the over clocking mode.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power supply with a frequency conversion function connected with a motherboard, the power supply comprising:
a pulse width modulation (PWM) controller generating a PWM signal;
a direct current-direct current (DC-DC) converter connected with the PWM controller and the motherboard and generating a plurality of voltages to the motherboard after the DC-DC converter receives the PWM signal; and
a switch resistor modulation circuit providing a first resistance value and a second resistance value to correspondingly generate the a first switching frequency or a second switching frequency;
wherein the second resistance value is larger than the first resistance value, and the second switching frequency is smaller than the first switching frequency.

2. The power supply with frequency conversion function according to claim 1, wherein the switch resistor modulation circuit further comprises a first switch and a second switch, and when the first switch and the second switch are triggered, respectively, the first resistance value and the second resistance value are correspondingly generated.

3. The power supply with frequency conversion function according to claim 2, wherein the switch resistor modulation circuit further comprises:
a first control circuit connected with the first switch, wherein when the first switch is triggered, the first control circuit connects a first switch resistor of the PWM controller; and
a second control circuit connected with the second switch, wherein when the second switch is triggered, the second control circuit connects a second switch resistor in series with the first switch resistor and connects the second switch resistor and the first switch resistor of the PWM controller.

4. The power supply with frequency conversion functions according to claim 1, wherein the PWM controller comprises a reference voltage pin and a switch resistor/capacitor pin.

5. The power supply with frequency conversion function according to claim 1, further comprising an electromagnetic interference (EMI) and bridge rectifier and an active power factor correction (PFC) circuit, wherein the active PFC circuit is connected with the DC-DC converter and the EMI and bridge rectifier is connected with the active PFC circuit.

6. A power supply with a frequency conversion function connected with a motherboard of, the power supply comprising:
a PWM controller generating a PWM signal;
a DC-DC converter connected with the PWM controller and the motherboard and generating a plurality of voltages to the motherboard after the DC-DC converter receives the PWM signal; and
a switch resistor modulation circuit providing a first resistance value, a second resistance value, and a third resistance value to correspondingly generate a first switching frequency, a second switching frequency, or a third switching frequency;
wherein the second resistance value is larger than the first resistance value, the first resistance value is larger than the third resistance value, the third switching frequency is larger than the first switching frequency, and the first switching frequency is larger than the second switching frequency.

7. The power supply with the frequency conversion function according to claim 6, wherein the switch resistor modulation circuit further comprises a first switch, a second switch, and a third switch, and the first resistance value, the second resistance value, and the third resistance value are correspondingly generated when the first switch, the second switch, and the third switch are triggered, respectively.

8. The power supply with the frequency conversion function according to claim 7, wherein the switch resistor modulation circuit further comprises:
a first control circuit connected with the first switch, wherein when the first switch is triggered, the first control circuit connects a first switch resistor with the two pins of the PWM controller;
a second control circuit connected with the second switch, wherein when the second switch is triggered, the second control circuit connects a second switch resistor in series with the first switch resistor and connects the second switch resistor and the first switch resistor with the PWM controller; and
a third control circuit connected with the third switch, wherein when the third switch is triggered, the third control circuit connects a third switch resistor in parallel with a fourth switch resistor and connects the third switch resistor and the fourth switch resistor the third switch resistor with the PWM controller;
wherein an equivalent resistance value of the third switch resistor and the fourth switch resistor connected in parallel is the third resistance value.

9. The power supply with the frequency conversion functions according to claim 6, wherein the PWM controller comprises are a reference voltage pin and a switch resistor/capacitor pin.

10. The power supply with the frequency conversion function according to claim 6, further comprising an EMI and bridge rectifier and an active PFC circuit, wherein the active PFC circuit is connected with the DC-DC converter, and the EMI and bridge rectifier is connected with the active PFC circuit.

11. A computer system comprising:
a motherboard; and
a power supply connected with the motherboard and capable of providing a plurality of voltages; wherein the power supply includes:
a PWM controller generating a PWM signal;
a DC-DC converter connected with the PWM controller and the motherboard and generating the voltages to the motherboard after the DC-DC converter receives the PWM signal; and
a switch resistor modulation circuit providing a first resistance value and a second resistance value switched to correspondingly generate a first switching frequency or a second switching frequency;
wherein the second resistance value is larger than the first resistance value and the second switching frequency is smaller than the first switching frequency.

12. The computer system according to claim 11, wherein the switch resistor modulation circuit further comprises a first switch and a second switch, and the first resistance value and the second resistance value are correspondingly generated when the first switch and the second switch are triggered, respectively.

13. The computer system according to claim 12, wherein the switch resistor modulation circuit further comprises:
a first control circuit connected with the first switch, wherein when the first switch is triggered, the first control circuit connects a first switch resistor with the two pins of the PWM controller; and
a second control circuit connected with the second switch, wherein when the second switch is triggered, the second control circuit connects a second switch resistor in series with the first switch resistor and connects the second switch resistor and the first switch resistor with the PWM controller.

14. The computer system according to claim 11, wherein the PWM controller comprise a reference voltage pin and a switch resistor/capacitor pin.

15. The computer system according to claim 11, further comprising an EMI and bridge rectifier and an active PFC circuit, wherein the active PFC circuit is connected with the DC-DC converter, and the EMI and bridge rectifier is connected with the active PFC circuit.
